(19) United States
(12) Patent Application Publication
(10) Pub. No.: US 2013/0153742 A1
(43) Pub. Date: Jun. 20, 2013

(54) ARRANGEMENT FOR HOLDING A PARTICLE BEAM APPARATUS

(71) Applicants: Jürgen POMMERENKE, Heidenheim (DE); Matthias Langer, Heubach (DE)

(72) Inventors: Jürgen POMMERENKE, Heidenheim (DE); Matthias Langer, Heubach (DE)

(21) Appl. No.: 13/329,822

(22) Filed: Dec. 19, 2011

(51) Int. Cl. G02B 21/24

(52) U.S. Cl. 248/636

(57) ABSTRACT

An arrangement for holding a particle beam device, in particular an electron beam device, on at least one base structure, includes at least one receiving unit, at least one damping unit which is to be positioned between the base structure and the receiving unit, at least one damping element being arranged at the receiving unit, and at least one holding element being arranged at the damping element.

### BACKGROUND OF THE INVENTION

1. Technical Field

This application relates to the field of holding arrangements, and more particularly to the field of arrangements for holding a particle beam device, in particular an electron beam device such as a transmission electron microscope.

2. Description of the Related Art

A particle beam device, in particular a transmission electron microscope, is well-known in the art. A particle beam device comprises several components, such as a particle source for providing particles for a particle beam, several lenses for forming the particle beam, a specimen holder for holding a specimen to be examined and a detection device for detecting particles which arise from the interaction of the particles of the particle beam on one hand and the specimen on the other hand, for example a camera for recording an image. These components are generally arranged in a column of the particle beam device.

Transmission electron microscopes are also well-known in the art. A transmission electron microscope (TEM) substantially comprises the components mentioned above, wherein the particle source is an electron source and an electron optical set-up is provided in the column (electron optical column). For many applications, it is required for the TEM to have a high resolution. A resolution of 1 Å more or less is required for many important applications. However, ultimate stable operating conditions of the electron optical set-up are required, otherwise it is difficult to obtain a good resolution. Accordingly, the TEM environment must be stable, thereby preventing alterations in the optical conditions of the TEM. In particular, any AC stray fields, mechanical instabilities caused by building vibrations, acoustic noise and temperature changes have to be avoided or at least to be kept to a minimum. In particular, the electron optical column has to be of a high robustness regarding environmental influences.

A further particle beam device is known from the prior art. The particle beam device comprises a particle optical column including a particle source and particle optical components as well as a base structure comprising a plurality of hollow bodies. The particle column has a center of gravity and the particle optical column is suspended on the base structure with a suspension center substantially above the center of gravity of the particle optical column.

Moreover, an apparatus support with a damping characteristic is known from the prior art. The apparatus support comprises a rigid reinforcement component, encapsulated by a body of compliant material, particularly a composite of particulate mineral material and synthetic binder. The reinforcing component defines an opening at spacing from the upper side of the body and a mounting ring is embedded in the body so as to be disposed at least partly above the opening. The ring has a peripheral flange which is spaced apart from the plate and from the upper side of the body and overlaps the plate (reinforcing component) in vertical projection. Material of the body is thus disposed above the flange and also sandwiched between the flange and the plate so that a damping zone is present around the ring both above and below the flange.

It is referred to U.S. Pat. No. 6,969,854 B1 and US 2010/0102196 A1 with respect to the prior art, which are incorporated herein by reference.

There is a continuing demand for improving an arrangement for holding a particle beam device to stabilize the particle beam device so that it is isolated not only from distortions in the framework of the arrangement used, but also as a safeguard against undesirable effects of vibration or shocks resulting from influences.

### SUMMARY OF THE INVENTION

According to the system described herein, an arrangement for holding a particle beam device, in particular an electron beam device, on at least one base structure comprises at least one receiving unit and at least one damping unit which is to be positioned between the base structure and the receiving unit. The damping unit may be a shock absorber, for example a pneumatic shock absorber, a hydraulic shock absorber or a mechanical spring. Moreover, the arrangement comprises at least one damping element which is arranged at the receiving unit. Moreover, the arrangement comprises at least one holding element for holding a particle beam device. The holding element is arranged at the damping element.

The receiving unit may comprise one single receiving element or may comprise several receiving elements. For example, the several receiving elements may be arranged on top of each other. The several receiving elements may also be arranged side by side.

The system described herein is based on the deliberation that the base structure may have a high rigidity and a high basic resonance frequency. The base structure may be any kind of base structure such as a floor of a building or a metal structural device, for example. Instead of providing a rather rigid connection between the receiving unit and the holding element comprising the particle beam device, the holding element is arranged at a damping element which may comprise high damping characteristics. Resonances and natural vibrations of the receiving unit, which may be caused due to mechanical disturbances, are absorbed by the damping element and, therefore, impair the stability of the particle beam device to a lesser degree. This results in a low amplitude of the natural resonances of the arrangement.

The arrangement may comprise such an extension (for example in the form of at least one bracket, several brackets, at least one support unit or several support units) perpendicular to an optical axis of a particle beam device that the arrangement is capable of holding a particle beam device with a weight of higher than, for example, 1000 kg and with a center of mass being relatively high above the ground, resulting in a stable arrangement for any external forces.

The arrangement further facilitates using a receiving unit comprising metal plates to achieve a bending resistant construction having a rather high rigidity and a high load carrying capacity.

Additionally or alternatively, the damping element may be arranged between the receiving unit and the holding element such that the holding element has no direct connection to the receiving unit. This means that the receiving unit and the holding element are always arranged at a distance from each other.

Moreover, additionally or alternatively, the holding element may be arranged at least partly in the damping element. The holding element may comprise at least one anchor element which is arranged in the damping element for holding the particle beam device.

Additionally or alternatively, the arrangement may comprise at least a first holding element, at least a second holding element and at least a third holding element, wherein the first holding element, the second holding element and the third holding element are arranged at the damping element. The first holding element, the second holding element and the third holding element may be support structures for supporting the particle beam device.

Alternatively or additionally, the holding element may also be a cover element, for example a cover plate. The damping element is arranged between the cover element and the receiving unit. Therefore, the cover element is arranged at the damping element.

Additionally or alternatively, the damping element may comprise a surface. The cover element may cover the surface at least partly. In a possible embodiment, the cover element fully covers the surface.

Additionally or alternatively, the damping element may comprise at least one reinforcement element. For example, the reinforcement element may be arranged perpendicular to the cover element or the receiving unit. Moreover, the reinforcement element may be arranged at the receiving unit. Alternatively or additionally, the reinforcement element may be arranged at the cover element.

Additionally or alternatively, the receiving unit may be U-shaped. This shape provides a cavity in which the damping element may be arranged. The receiving unit may also be shaped like a bowl. The bowl may be filled with the damping element at least partly.

Additionally or alternatively, the receiving unit comprises at least a first wall unit, at least a second wall unit and at least a third wall unit. The first wall unit may adjoin to the second wall unit, and the second wall unit may adjoin to the third wall unit. Moreover, at least a first reinforcement unit may be arranged at the first wall unit and the second wall unit. Additionally or alternatively, at least a second reinforcement unit is arranged at the second wall unit and the third wall unit.

Additionally or alternatively, the damping element may be made of one of: mineral casting, a polymer, lead casting and lead. In particular, the use of mineral casting results in a reduction of the amplitude of natural vibrations, in a high damping of vibrations and in a shifting of resonance frequencies in non critical ranges.

Additionally or alternatively, the damping element may comprise a first structural-borne sound damping. The receiving unit (without the damping element), such as a mounting plate and/or a cover plate, for example, may comprise a second structural-borne sound damping. The first structural-borne sound damping may be higher than the second structural-borne sound damping.

Additionally or alternatively, the receiving unit may comprise at least one T-section. For example, the receiving unit may comprise a construction which is built in accordance with the principle of double T-section.

Alternatively or additionally, the receiving unit comprises at least one support unit which is arranged at the receiving unit. The support unit is also arranged at the damping unit. As mentioned above, the damping unit is arranged between the base structure and the receiving unit.

The system described herein also refers to a particle beam device being held by an arrangement on at least one base structure, which arrangement may comprise at least one receiving unit, at least one damping unit which is to be positioned between the base structure and the receiving unit, at least one damping element arranged at the receiving unit, and at least one holding element for holding the particle beam device, the holding element being arranged at the damping element.

The particle beam device may be any kind of particle beam device; for example, the particle beam device is one of: an electron beam device (such as a transmission electron microscope or a scanning electron microscope), a transmission particle beam device, a scanning particle beam device and an ion beam device.

### BRIEF DESCRIPTION OF THE DRAWINGS

Features and advantages of the system described herein will become more apparent from the following detailed description of exemplary embodiments thereof taken in conjunction with the accompanying drawings, in which:

FIG. 1 shows a schematic view of a first embodiment of an arrangement for holding a particle beam device;

FIG. 2 shows a schematic view of a second embodiment of an arrangement for holding a particle beam device;

FIG. 3 shows a schematic view of a third embodiment of an arrangement for holding a particle beam device;

FIG. 4 shows a schematic view of an embodiment of a receiving unit;

FIG. 5 shows a further schematic view of the receiving unit according to FIG. 4; and

FIG. 6 shows a schematic view of a fourth embodiment of an arrangement for holding a particle beam device.

### DETAILED DESCRIPTION OF VARIOUS EMBODIMENTS

The system described herein as now described refers to an arrangement for holding a TEM by way of example only. It should be noted that the system described herein also refers to any other arrangement for holding devices, in particular particle beam devices.

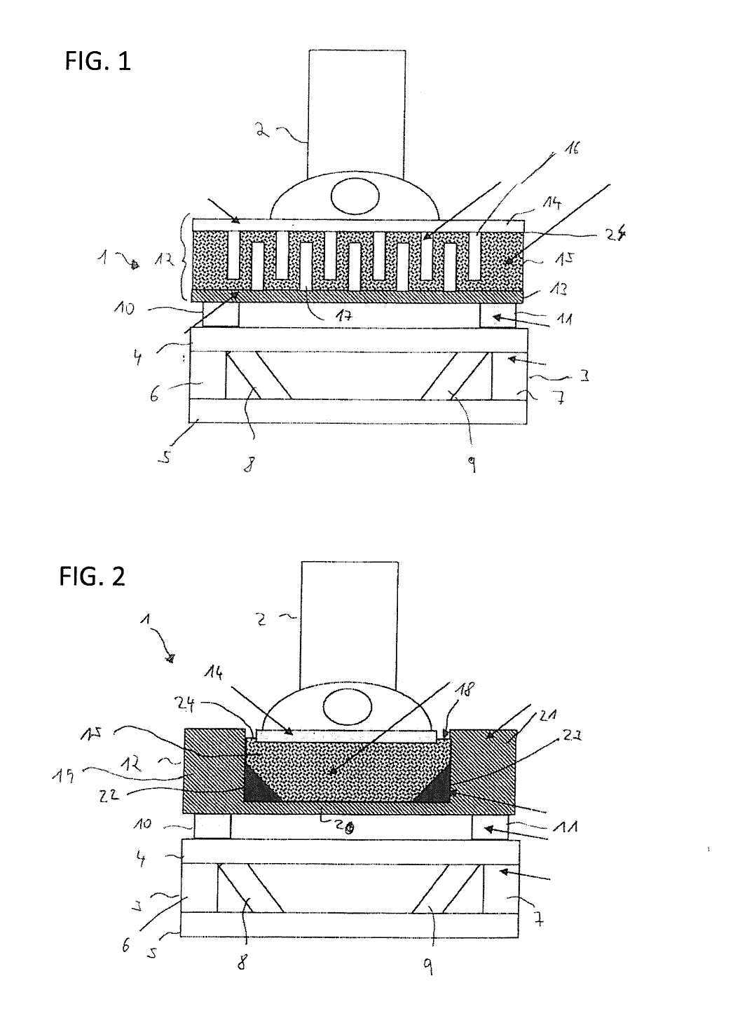

A schematic view of a first embodiment of an arrangement 1 for holding a TEM 2 is shown in FIG. 1. The arrangement 1 comprises a base structure 3 having an upper base element 4 and a lower base element 5. The upper base element 4 and the lower base element 5 are connected to each other via a first connecting element 6 and a second connecting element 7. Furthermore, a first stabilizer bar 8 and a second stabilizer bar 9 are connected to the upper base element 4 and the lower base element 5. The base structure 3 is of high rigidity and comprises a high basic resonance frequency, for example in the range of 100 Hz to 300 Hz.

It should be noted that the system described herein is not restricted to the base structure 3 as shown in FIG. 1. Instead, any suitable base structure 3 may be chosen. In particular, the base structure 3 may comprise less or more connecting elements and/or stabilizer bars. The base structure 3 may also be a floor of a building, for example.

The arrangement 1 also comprises a first damping unit 10 and a second damping unit 11 which are arranged at the upper base element 4. The first damping unit 10 and the second damping unit 11 may be vibration shock elements, for example pneumatic shock absorbers, hydraulic shock absorbers or a combination of mechanical springs and damping components. It should be noted that the system described herein is not restricted to two damping units. Instead, the arrangement 1 may comprise more or less damping units.

The first damping unit 10 and the second damping unit 11 are also arranged at a mounting plate 13 of a receiving unit 12. Therefore, the first damping unit 10 and the second damping unit 11 connect the base structure 3 and the receiving unit 12.

The receiving unit 12 comprises the mounting plate 13 and a damping element 15 A cover element 14 is arranged on top of the receiving unit 12 and may be a cover plate. Moreover, the cover element 14 may be a holding element for the TEM 2. The damping element 15 is arranged between the mounting plate 13 and the cover element 14. The damping element 15 may be a compliant material, particularly a composite of particulate mineral material and synthetic binder. For example, the damping element 15 is made of one of the following materials: mineral casting, a polymer, lead or lead casting. The damping element 15 comprises an upper surface 24 which is covered fully by the cover element 14.

The arrangement 1 also comprises first reinforcement elements 16 and second reinforcement elements 17. The first reinforcement elements 16 are arranged at the cover element 14. The second reinforcement elements 17 are arranged at the mounting plate 13. The first reinforcement elements 16 and the second reinforcement elements 17 may have any suitable shape and may be made of any suitable material. For example, the first reinforcement elements 16 and/or the second reinforcement elements 17 may have cylindrical shape and are made of steel. The first reinforcement elements 16 and the second reinforcement elements 17 may have two functions. On the one hand, the first reinforcement elements 16 and the second reinforcement elements 17 serve as anchor elements when casting the damping element 15 (such as a mineral casting, for example) into the receiving unit 12. On the other hand, the first reinforcement elements 16 and the second reinforcement elements 17 reinforce the structure of the receiving unit 12.

It should be noted that in the embodiment shown in FIG. 1 the cover element 14 is only connected to the mounting plate 13 via the damping element 15. However, there is no direct contact between the cover element 14 and the mounting plate 13.

FIG. 2 shows a schematic view of a second embodiment of the arrangement 1, also for holding the TEM 2. The second embodiment of FIG. 2 is based on the first embodiment of FIG. 1. Identical units are marked with identical reference signs. In contrast to the first embodiment of FIG. 1, the second embodiment of FIG. 2 comprises a receiving unit 12 which is U-shaped and formed like a bowl. The receiving unit 12 comprises an interior space 18 in which the damping element 15 is arranged. The receiving unit 12 comprises a first wall unit 19, a second wall unit 20 and a third wall unit 21. The receiving unit 12 may comprise more or less wall units. The first wall unit 19 adjoins to the second wall unit 20. Moreover, the second wall unit 20 adjoins to the third wall unit 21. The receiving unit 12 also comprises a first reinforcement unit 22 which is arranged at the first wall unit 19 and the second wall unit 20. Additionally, there is a second reinforcement unit 23 which is arranged at the second wall unit 20 and the third wall unit 23. The first wall unit 19, the second wall unit 20 and the third wall unit 21 (and—if there is another wall unit of the receiving unit 12) form the interior space 18 in which the damping element 15 is arranged.

The cover element 14 is again arranged at the upper surface 24 of the damping element 15. However, the cover element 14 does not fully cover the upper surface 24 of the damping element 15. Instead, the cover element 14 is arranged at the upper surface 24 in such a way that there is a space between an edge of the cover element 14 and the receiving unit 12. Moreover, the cover element 14 of this embodiment is a holding element for the TEM 2.

As shown in the embodiment according to FIG. 2, the cover element 14, to which the TEM 2 may be attached, is not in any direct contact to any rigid element of the receiving unit 12 such as any of the first wall unit 19, the second wall unit 20 and the third wall unit 21. Instead, the cover element 14 is only connected to any rigid component of the receiving unit 12 via the damping element 15.

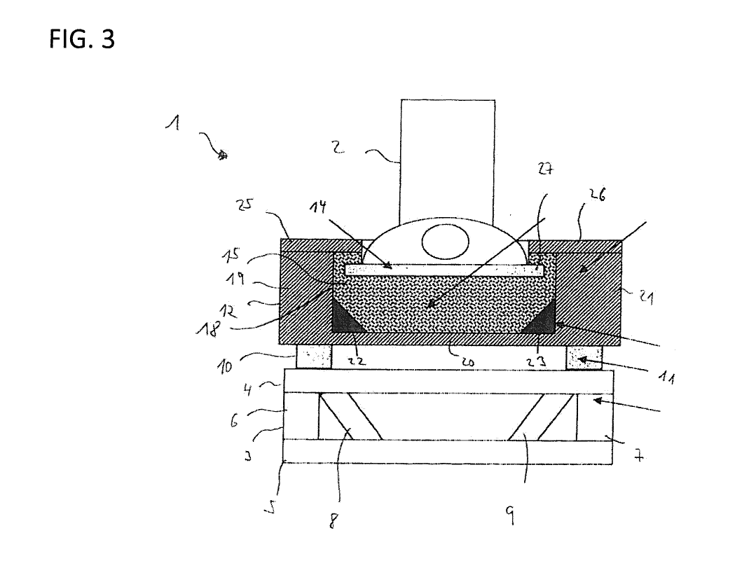

FIG. 3 shows a schematic view of a third embodiment of the arrangement 1. The third embodiment of FIG. 3 is based on the second embodiment of FIG. 2. Therefore, identical units are marked with identical reference signs. In contrast to the second embodiment of FIG. 2, the arrangement 1 of the third embodiment of FIG. 3 comprises a receiving unit 12 having a first cover unit 25 and a second cover unit 26 which cover partly the interior space 18. The cover element 14 is arranged in the interior space 18 and is partly covered at its edges 27 by the damping element 15. The first cover unit 25 and the second cover unit 26 are arranged in such a way that the damping element 15 is kept in the interior space 18. The damping element 15 may be arranged at the first cover unit 25 and the second cover unit 26. Again, the cover element 14 is the holding element for the TEM 2.

As shown in the embodiment shown in FIG. 3, the cover element 14, to which the TEM 2 may be attached, is not in any direct contact to any rigid element of the receiving unit 12 such as the cover unit 25 or the second cover unit 26 or any of the first wall unit 19, the second wall unit 20 and the third wall unit 21. Instead, the cover element 14 is only connected to any rigid component of the receiving unit 12, such as the first cover unit 25, the second cover unit 26 or any of the first wall unit 19, the second wall unit 20 and the third wall unit 21 via the damping element 15.

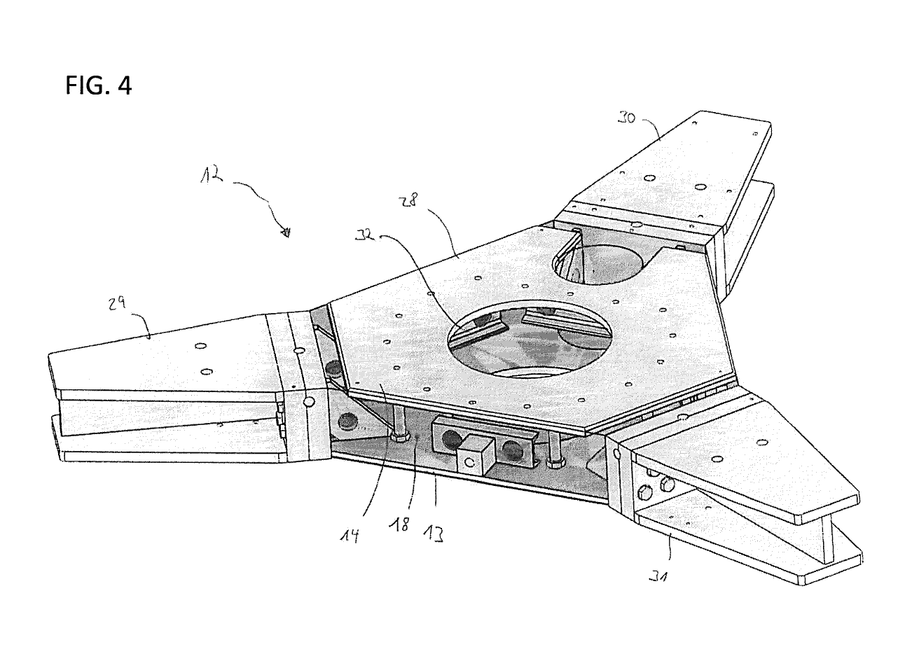

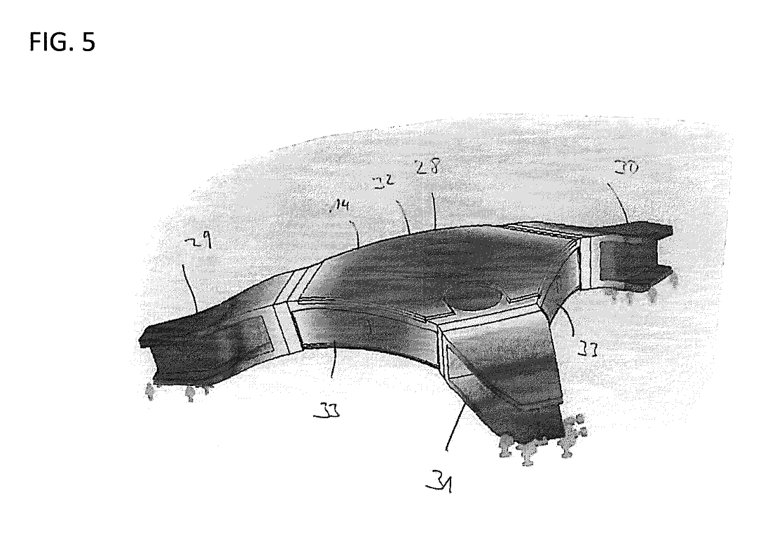

FIG. 4 shows a further embodiment of the receiving unit 12. The receiving unit 12 comprises a middle unit 28 comprising the mounting plate 13 and the cover element 14. The mounting plate 13 and the cover element 14 are arranged in such a way that the interior space 18 is formed between the mounting plate 13 and the cover element 14. The interior space 18 is filled with the damping element 15 (not shown). The receiving unit 12 also comprises a first support unit 29, a second support unit 30 and a third support unit 31 which are arranged in a 120° arrangement at the middle unit 28. The first support unit 29, the second support unit 30 and the third support unit 31 have a double T-section. This means that a cross section through each of the first support unit 29, the second support unit 30 and the third support unit 31 has the form of a double capital letter T (or the form of the capital letter H rotated 90° around an horizontal axis). Accordingly, a T-section means that a cross section through a mechanical element has the form of a capital letter T. The middle unit 28 comprises an opening 32. The TEM 2 is arranged on top of the cover element 14. Moreover, a section of the TEM 2 penetrates through the opening 32 of the middle unit 28. The middle unit 28 may also comprise side cover elements 33 to cover the interior space 18, as shown in FIG. 5.

As also shown in the embodiment of FIG. 4, the cover element 14 is only connected to the mounting plate 13 via the damping element 15. However, there is no direct contact between the cover element 14 and the mounting plate 13.

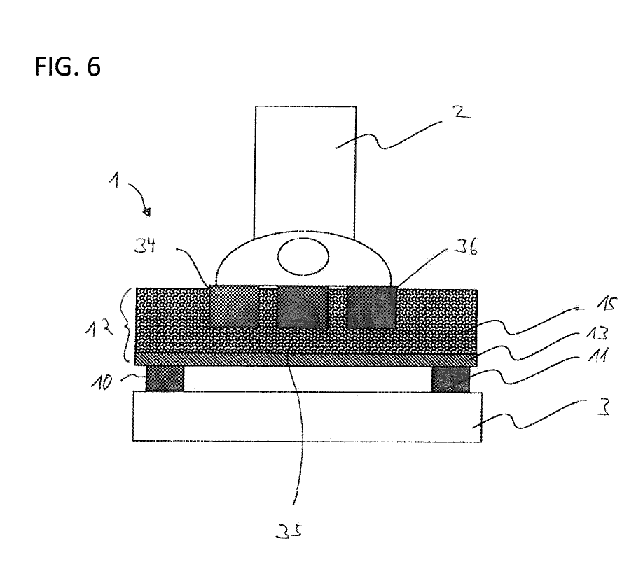

FIG. 6 shows a schematic view of a fourth embodiment of the arrangement 1. The fourth embodiment of FIG. 6 is based on the first embodiment of FIG. 1. Therefore, identical units are marked with identical reference signs. In contrast to the first embodiment of FIG. 1, the arrangement 1 of the fourth embodiment of FIG. 6 comprises a base structure 3 which is a floor of a building or a metal plate, for example. Moreover, the receiving unit 12 comprises the mounting plate 13 and the damping element 15. However, this embodiment does not comprise a cover plate. Instead, a first holding element 34, a second holding element 35 and a third holding element 36 are arranged at the damping element 15. The first holding element 34, the second holding element 35 and the third holding element 36 hold the TEM 2.

The base structure 3 may have a high rigidity and a high basic resonance frequency, as mentioned above. Instead of providing a rather rigid connection between the receiving unit 12 and the holding element in the form of the cover element 14, the holding element is arranged at the damping element 15 which may comprise high damping characteristics. Resonances and natural vibrations of the receiving unit 12, which may be caused due to mechanical disturbances, are absorbed by the damping element 15 and, therefore, impair the stability of the TEM 2 to a lesser degree.

The damping element 15 comprises a first structural-borne sound damping, whereas the receiving unit 12 (without the damping element 15) comprises a second structural-borne sound damping. The first structural-borne sound damping is higher than the second structural-borne sound damping.

The arrangement 1 comprises such an extension (for example in the form of at least one bracket, several brackets, at least one support unit or several support units such as the first support unit 29, the second support unit 30 and the third support unit 31) perpendicular to an optical axis of the TEM 2 that the arrangement 1 is capable of carrying a weight of higher than, for example, 1000 kg and with a center of mass being relatively high above the ground, resulting in a stable arrangement 1 for any external forces.

As shown in the embodiment of FIG. 6, none of the holding elements 34, 35, 36, to which the TEM 2 may be attached is in direct contact to any rigid component of the receiving unit such as the mounting plate 13. Instead, each of the holding elements 34, 35,36 is connected to any rigid component of the receiving unit only via the damping element 15.

While the invention has been disclosed in connection with preferred embodiments shown and described in detail, various modifications and improvements thereon will become readily apparent to those skilled in the art. Accordingly, the spirit and scope of the present invention is to be limited only by the following claims.

What is claimed is:

1. Arrangement for holding a particle beam device on at least one base structure, comprising:
at least one receiving unit,
at least one damping unit which is to be positioned between the base structure and the receiving unit;
at least one damping element being arranged at the receiving unit; and
at least one holding element being arranged at the damping element.

2. The arrangement according to claim 1, wherein the damping element is arranged between the receiving unit and the holding element such that the holding element has no direct connection to the receiving unit.

3. The arrangement according to claim 1, wherein the holding element is arranged at least partly in the damping element.

4. The arrangement according to claim 3, wherein the holding element is an anchor element.

5. The arrangement according to claim 1, further comprising:
at least a first holding element, at least a second holding element and at least a third holding element, wherein the first holding element, the second holding element and the third holding element are arranged at the receiving unit.

6. The arrangement according to claim 1, wherein
the holding element is a cover element, and wherein
the damping element is arranged between the cover element and the receiving unit.

7. The arrangement according to claim 6, wherein the cover element is a cover plate.

8. The arrangement according to claim 6, wherein
the damping element comprises at least one surface, and wherein
the cover element covers the surface at least partly.

9. The arrangement according to claim 1, wherein the damping element comprises at least one reinforcement element.

10. The arrangement according to claim 9, wherein the reinforcement element is arranged at the receiving unit.

11. The arrangement according to claim 6, wherein the damping element comprises at least one reinforcement element being arranged at the cover element.

12. The arrangement according to claim 1, wherein the receiving unit is U-shaped.

13. The arrangement according to claim 1, wherein
the receiving unit is shaped like a bowl, and wherein
the bowl is filled with the damping element at least partly.

14. The arrangement according to claim 1, wherein
the receiving unit comprises at least a first wall unit, at least a second wall unit and at least a third wall unit,
the first wall unit adjoins to the second wall unit and the second wall unit adjoins to the third wall unit,
at least a first reinforcement unit is arranged at the first wall unit and the second wall unit, and wherein
at least a second reinforcement unit is arranged at the second wall unit and the third wall unit.

15. The arrangement according to claim 1, wherein the damping element is made of one of: mineral casting, a polymer, lead casting and lead.

16. The arrangement according to claim 1, wherein the damping element comprises a first structural-borne sound damping, wherein the receiving unit comprises a second structural-borne sound damping and wherein the first structural-borne sound damping is higher than the second structural-borne sound damping.

17. The arrangement according to claim 1, wherein the receiving unit comprises at least one T-section.

18. The arrangement according to claim 1, wherein the receiving unit comprises at least one support unit which is arranged at the receiving unit.

19. Particle beam device being held by an arrangement on at least one base structure, the arrangement comprising:
at least one receiving unit;
at least one damping unit which is to be positioned between the base structure and the receiving unit;
at least one damping element being arranged at the receiving unit; and
at least one holding element being arranged at the damping element.

20. The particle beam device according to claim 19, wherein the particle beam device is one of: an electron beam device, a transmission particle beam device, a scanning particle beam device and an ion beam device.
